(19) United States
(12) Patent Application Publication
(10) Pub. No.: US 2023/0114326 A1
(43) Pub. Date: Apr. 13, 2023

(54) DISTRIBUTED STORAGE VOLUME ONLINE MIGRATION METHOD, SYSTEM, AND APPARATUS, AND READABLE STORAGE MEDIUM

(71) Applicant: INSPUR SUZHOU INTELLIGENT TECHNOLOGY CO., LTD., Suzhou, Jiangsu (CN)

(72) Inventors: Zhanhao BAI, Suzhou, Jiangsu (CN); Duan ZHANG, Suzhou, Jiangsu (CN)

(21) Appl. No.: 17/801,278

(22) PCT Filed: Jan. 7, 2021
(86) PCT No.: PCT/CN2021/070570

§ 371 Date: Aug. 22, 2022

(30) Foreign Application Priority Data
Feb. 21, 2020 (CN) 202010108877.8

(51) Int. Cl. G06F 3/06

(52) U.S. Cl. CPC G06F 3/0601; G06F 3/067

(57) ABSTRACT

A distributed storage volume online migration method, system, and apparatus, and a computer-readable storage medium, include: obtaining a metadata object that stores metadata of an original volume; creating a metadata context handle and a data context handle in a target storage pool corresponding to a migration instruction; storing the metadata object to the metadata context handle; storing, to a target volume, an original volume information field in the metadata object; sequentially copying data objects in the original volume to the target volume; and recording an Identifier (ID) of a completely copied data object in the target volume.

This application claims priority to Chinese Patent Application No. 202010108877.8, filed on Feb. 21, 2020, in China National Intellectual Property Administration and entitled “Distributed Storage Volume Online Migration Method, System, and Apparatus, and Readable Storage Medium”, the contents of which are hereby incorporated by reference in its entirety.

### FIELD

The present disclosure relates to the field of distributed storage, and particularly to a distributed storage volume online migration method, system, and apparatus, and a computer-readable storage medium.

### BACKGROUND

Rados Block Device (RBD) is the most widely used and stable in three storage types provided by ceph. Like a disk, a RBD is mountable to a physical machine or a virtual machine.

Through a Transmission Control Protocol (TCP)/Internet Protocol (IP) technology, Internet Small Computer System Interface (iSCSI) mainly makes, through an iSCSI target function, a storage device (RBD) a server capable of providing a disk, and then makes, through an iSCSI initiator function, the storage device a client capable of mounting and using an iSCSI target. As such, disk application may be implemented through an iSCSI protocol.

A client may be connected with a tgt by the above method to access an underlying librbd to implement an operation for block storage. Multiple block devices may be mapped to a target. In addition, multiple targets may be created on a tgt. The client may be connected with one or more targets on the tgt for respective access. The tgt may create a Logical Unit Number (LUN) to provide block service for the client. A LUN corresponds to a block storage volume.

In virtualization and data scenarios, users have online migration (live migration) requirements for no crash and continuous service provision of virtual machines during migration or accessibility of databases during migration and smooth transition to new databases after migration. However, the prior art only supports offline migration.

Therefore, there is an urgent need for a distributed storage volume online migration method.

### SUMMARY

In view of this, an objective of the present disclosure is to provide a distributed storage volume online migration method, system, and apparatus, and a computer-readable storage medium, to implement non-perceptual distributed storage volume online migration. Specific solutions are as follows.

A distributed storage volume online migration method is disclosed, including:

receiving a migration instruction sent by a user terminal;

obtaining, by use of the migration instruction, a metadata object that stores metadata of an original volume, the original volume is a volume that corresponds to the migration instruction and includes data required to be migrated to a target volume;

creating a metadata context handle and a data context handle in a target storage pool corresponding to the migration instruction, the target storage pool corresponds to the target volume corresponding to the migration instruction;

storing the metadata object to the metadata context handle such that the target storage pool is accessible by use of information corresponding to the metadata object;

storing, to the target volume, an original volume information field in the metadata object such that the target volume is accessible by use of information corresponding to the original volume information field;

sequentially copying data objects in the original volume to the target volume in order of Identifiers (IDs) of the data objects in the original volume; and

recording the ID of a latest completely copied data object in the target volume so as to determine a migration progress of the data objects by use of the ID of the data object.

In some embodiments, the metadata object includes a volume name object, a volume ID object, and a volume header object.

In some embodiments, the method further includes:

setting a migration flag for the target volume.

In some embodiments, the step of sequentially copying data objects in the original volume to the target volume includes:

sequentially copying the data objects in the original volume to the target volume through a memory.

In some embodiments, after the step of recording the ID of the latest completely copied data object in the target volume, the method further includes:

recording the ID of the latest completely copied data object in the memory so as to determine the migration progress of the data objects by use of the ID of the data object in the memory.

In some embodiments, the method further includes:

deleting the original volume after the data of the original volume is all migrated.

In some embodiments, the step of creating the metadata context handle and the data context handle in the target storage pool corresponding to the migration instruction includes:

creating the metadata context handle in a target metadata storage pool corresponding to the migration instruction; and

creating the data context handle in a target data storage pool corresponding to the migration instruction.

Embodiments of the present disclosure also disclose a distributed storage volume online migration system, including:

an instruction receiving module, configured to receive a migration instruction sent by a user terminal;

a metadata obtaining module, configured to obtain, by use of the migration instruction, a metadata object that stores metadata of an original volume, the original volume is a volume that corresponds to the migration instruction and includes data required to be migrated to a target volume;

a handle creation module, configured to create a metadata context handle and a data context handle in a target storage pool corresponding to the migration instruction, the target storage pool corresponds to the target volume corresponding to the migration instruction;

a metadata handle storage module, configured to store the metadata object to the metadata context handle such that the target storage pool is accessible by use of information corresponding to the metadata object;

an original volume information storage module, configured to store, to the target volume, an original volume information field in the metadata object such that the target volume is accessible by use of information corresponding to the original volume information field;

a data migration module, configured to sequentially copy data objects in the original volume to the target volume in order of IDs of the data objects in the original volume; and an object ID recording module, configured to record the ID of a latest completely copied data object in the target volume so as to determine a migration progress of the data objects by use of the ID of the data object.

The embodiments of the present disclosure also disclose a distributed storage volume online migration apparatus, including:

a memory, configured to store a computer program; and

a processor, configured to execute the computer program to implement the afore-mentioned distributed storage volume online migration method.

The embodiments of the present disclosure also disclose a computer-readable storage medium, storing a computer program that is executed by a processor to implement the afore-mentioned distributed storage volume online migration method.

In the present disclosure, the distributed storage volume online migration method includes: receiving a migration instruction sent by a user terminal; obtaining, by use of the migration instruction, a metadata object that stores metadata of an original volume, the original volume is a volume that corresponds to the migration instruction and includes data required to be migrated to a target volume; creating a metadata context handle and a data context handle in a target storage pool corresponding to the migration instruction, the target storage pool corresponds to the target volume corresponding to the migration instruction; storing the metadata object to the metadata context handle such that the target storage pool is accessible by use of information corresponding to the metadata object; storing, to the target volume, an original volume information field in the metadata object such that the target volume is accessible by use of information corresponding to the original volume information field; sequentially copying data objects in the original volume to the target volume in order of IDs of the data objects in the original volume; and recording the ID of a latest completely copied data object in the target volume so as to determine a migration progress of the data objects by use of the ID of the data object.

According to the present disclosure, the metadata object of the original volume is stored to the target storage pool and the target volume without destroying an original index relationship of the data in the original volume, whereby the target volume may be accessed by use of information of the original volume, and meanwhile, the data of the original volume may still be accessed during migration by use of the ID of the data object. In addition, access to data that has been migrated to the target volume is prioritized, and the data in the original data is no longer used as much as possible after migration. Therefore, non-perceptual storage volume online migration is implemented.

### BRIEF DESCRIPTION OF THE DRAWINGS

In order to describe the technical solutions in embodiments of the present disclosure or the prior art more clearly, the drawings required to be used in descriptions about the embodiments or the prior art will be introduced briefly below. Apparently, the drawings in the description below are merely embodiments of the present disclosure. Those ordinarily skilled in the art may further obtain other drawings according to the provided drawings without creative work.

FIG. 1 is a schematic flowchart of a distributed storage volume online migration method according to an embodiment of the present disclosure;

FIG. 2 is a schematic diagram of communication in a distributed storage volume online migration process according to an embodiment of the present disclosure;

FIG. 3 is a schematic flowchart of another distributed storage volume online migration method according to an embodiment of the present disclosure;

FIG. 4 is a schematic structural diagram of a distributed storage volume online migration system according to an embodiment of the present disclosure; and

FIG. 5 is a schematic structural diagram of a distributed storage volume online migration apparatus according to an embodiment of the present disclosure.

### DETAILED DESCRIPTION

The technical solutions in the embodiments of the present disclosure will be described clearly and completely below in combination with the drawings in the embodiments of the present disclosure. Clearly, the described embodiments are not all but only part of embodiments of the present disclosure. All other embodiments obtained by those ordinarily skilled in the art based on the embodiments in the present disclosure without creative work shall fall within the scope of protection of the present disclosure.

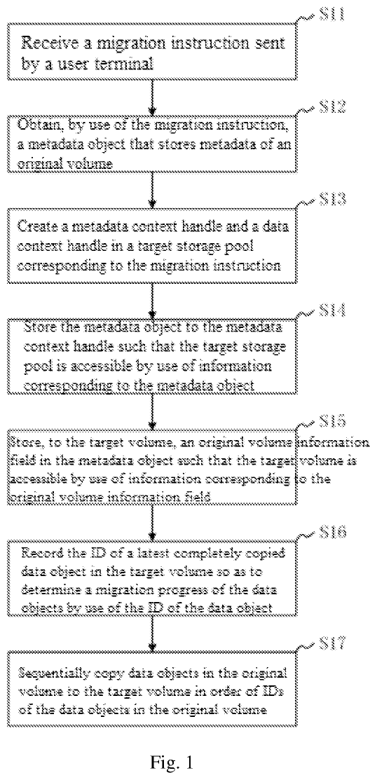

An embodiment of the present disclosure discloses a distributed storage volume online migration method. As shown in FIG. 1, the method includes the following steps.

At S11, a migration instruction sent by a user terminal is received.

It can be understood that, when users need to migrate data from one volume to another, they can transmit a migration instruction through a user terminal for data migration. The migration instruction records related information of the original volume whose data needs to be migrated and the target volume to which the data needs to be migrated. A storage pool corresponding to each volume may be accessed by use of such information to copy data and store data.

At S12, a metadata object that stores metadata of an original volume is obtained by use of the migration instruction.

The original volume is accessed from the corresponding storage pool by use of the related information of the original volume recorded in the migration instruction, such as metadata information, to obtain a metadata object that stores metadata of the original volume.

The metadata object may include a volume name object, a volume ID object, and a volume header object. The volume name object is an object that stores a name of the volume. The volume ID object is an object that stores a unique ID of the volume. The volume header object may store creation time and final rewrite time of data in the volume, attribute information of the volume, attribute information of the data in the volume, and other contents.

The original volume may be accessed accurately by use of the metadata object of the original volume.

At S13, a metadata context handle and a data context handle are created in a target storage pool corresponding to the migration instruction, the target storage pool includes a target volume corresponding to the migration instruction.

The target volume receiving the data needs to be prepared according to the migration instruction. In order to ensure complete and correct migration of the data of the original volume to the target volume, a newly created volume or pre-created blank volume, i.e., a volume that does not store any data, may be used as the target volume. The target volume may also be a pre-created volume where there is data stored. In order to retain a mapping relationship of the original volume, a new metadata context handle and data context handle specially for storing new migrated data may be created, to ensure the independence of the data and avoid data damage and loss.

A storage pool corresponds to multiple volumes, and when a new volume is created, it is unnecessary to divide a corresponding space in the storage pool to generate the new volume. Therefore, to establish a mapping relationship between a target storage pool and a target volume, a metadata context handle and a data context handle of the target storage pool are created to update and/or query metadata information of a volume in the target storage pool by use of the metadata context handle and read/write data in the target storage pool by use of the data context handle.

It is to be noted that there is no requirement for the sequence of S12 and S13, and they may be executed at the same time or respectively in sequence.

The metadata context handle and the data context handle may be stored in a ctx form to obtain a metadata context handle dst_md_ctx and a data context handle dst_data_ctx.

At S14, the metadata object is stored to the metadata context handle such that the target storage pool is accessible by use of information corresponding to the metadata object.

At S15, an original volume information field in the metadata object is stored to the target volume such that the target volume is accessible by use of information corresponding to the original volume information field.

The metadata object of the original volume is stored to the metadata context handle of the target storage pool. As such, even though the user accesses data that has been migrated in the original volume by use of information of the original volume, such as information of a path and name of the original volume, the system may still point to the target storage pool according to the information of the original volume. Similarly, the target volume also stores an original volume information field in the metadata object of the original volume. The original volume information field includes the volume name object and volume ID object of the original volume. After the target storage pool is accessed, the target volume may be found by use of the original volume information field according to the information of the original volume, thereby accessing migrated data. After the data is migrated, an original mapping relationship between index data and practical data is not destroyed, and the user needs not to change an index condition intentionally. Therefore, non-perceptual data online migration is implemented.

At S16, data objects in the original volume are sequentially copied to the target volume in order of IDs of the data objects in the original volume.

At S17, the ID of a latest completely copied data object is recorded in the target volume so as to determine a migration progress of the data objects by use of the ID of the data object.

It can be understood that the data is migrated on line, and in addition, the original volume usually includes a large volume of data that cannot be migrated completely at one time during migration and thus needs to be migrated at multiple times. Therefore, to ensure that the user can still access the data of the original volume during migration, it is necessary to determine whether data currently required to be accessed has been completely migrated and stored to the target volume or is temporarily yet not migrated and still stored in the original volume. IDs of data objects are used for judgment.

Data is sequentially stored in the original volume during data storage. Therefore, IDs of data objects in the original volume are arranged from small to large. During migration, the data is also sequentially migrated according to the IDs of the data objects. The data may also be sequentially migrated from small to large IDs of the data objects. For example, a data object whose ID is 1 is migrated first, and then a data object whose ID is 2 is migrated. In such case, an ID of a latest completely copied data object in the target volume may be judged to confirm a migration progress, thereby determining whether a data object required to be accessed has been migrated. For example, the ID of the current latest completely migrated data object is 2. In such case, if the ID of the data object required to be accessed is 1, smaller than that of the current latest completely migrated data object, since the migration order is from small to large IDs of the data objects, the data object whose ID is 1 has been copied to the target volume, and the data object is accessed through the target volume. If the ID of the data object required to be accessed is 3, larger than the ID 2 of the current latest completely migrated data object, it indicates that the data object is yet not migrated and still stored in the original volume, and the data object is accessed through the original volume.

It can be understood that, in order to avoid the influence of an access request during data migration on the migration progress, the data is copied for migration during migration, and meanwhile, access is preferentially guided to the target volume. Therefore, it may be maximally ensured that there is no data object that has not been accessed in the original volume after migration, and then the original volume may be deleted as soon as possible to complete data migration of the original volume.

In addition, recording the ID of the latest completely copied data object may support breakpoint resume during migration, and a data object corresponding to the next ID of the ID of the latest completely copied data object may continue to be migrated after interruption of the migration. For example, if the ID of the current latest completely copied data object is 2, the data object whose ID is 3 may start to be migrated when migration is restarted.

During migration, how many times the data is to be migrated and a data size in each migration may be determined according to a volume size, a block size, and a stripe length. The data size in each migration may be a stripe, an object, or n objects, and may be dynamically regulated by the user through a configuration item. The data size in each migration defaults to an object that may be set to 4 MB.

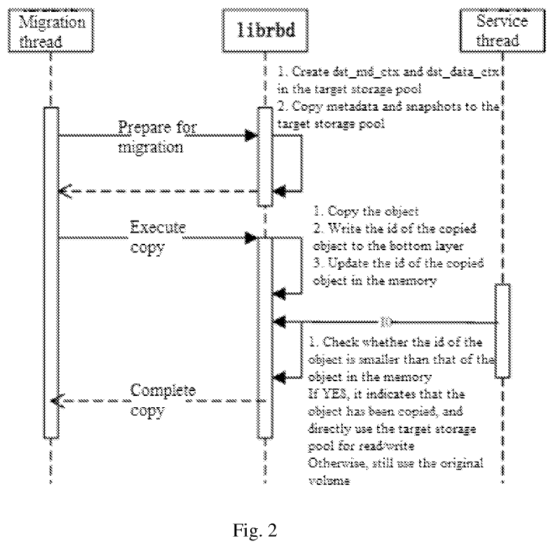

The embodiment of the present disclosure may run in a distributed storage system under a linux platform, and an iSCSI architecture may be used to implement an operation for block storage by tgt creation and connection for access to an underlying librbd. The data migration process may be completed by a special migration thread. For example, as shown in FIG. 2, the librbd is responsible for the management of storage blocks, storage pools, and volumes, and thus executes data change related services. The service thread is responsible for processing access Input/Output (JO) services input by user terminals and accessing data objects. The migration thread is responsible for sending migration instructions to complete migration tasks.

It is to be noted that the data context handle is updated during migration, so as to subsequently access the target volume by use of the data context handle through the target storage pool.

It can be seen that, according to the embodiment of the present disclosure, the metadata object of the original volume is stored to the target storage pool and the target volume without destroying an original index relationship of the data in the original volume, whereby the target volume may be accessed by use of information of the original volume, and meanwhile, the data of the original volume may still be accessed during migration by use of the ID of the data object. In addition, access to data that has been migrated to the target volume is prioritized, and the data in the original data is no longer used as much as possible after migration. Therefore, non-perceptual storage volume online migration is implemented.

According to the embodiment of the present disclosure, a distributed block storage logical volume may be migrated from one storage pool to another without stopping and manual switching of tgt or openstack. In addition, the metadata object of the original volume is retained in the target storage pool, and the original volume information field of the original volume is retained in the target volume, whereby deletion and manual switching of mappings are avoided.

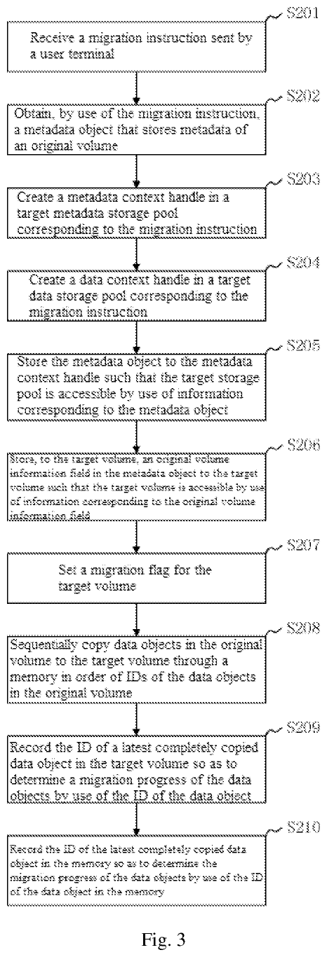

An embodiment of the present disclosure discloses a specific distributed storage volume online migration method. Compared with the previous embodiment, the technical solution is further described and optimized in the present embodiment. As shown in FIG. 3, the method includes the following steps.

At S201, a migration instruction sent by a user terminal is received.

At S202, a metadata object that stores metadata of an original volume is obtained by use of the migration instruction, the original volume is a volume that corresponds to the migration instruction and includes data required to be migrated to a target volume.

At S203, a metadata context handle is created in a target metadata storage pool corresponding to the migration instruction.

At S204, a data context handle is created in a target data storage pool corresponding to the migration instruction.

Metadata and practical data may be stored in two storage pools respectively. For example, a metadata storage pool is exclusively used to store a metadata context handle, and a target data storage pool is exclusively used to store a data context handle. Certainly, the target metadata storage pool and the target data storage pool both correspond to the target volume.

At S205, the metadata object is stored to the metadata context handle such that the target storage pool is accessible by use of information corresponding to the metadata object.

At S206, an original volume information field in the metadata object is stored to the target volume such that the target volume is accessible by use of information corresponding to the original volume information field.

At S207, a migration flag is set for the target volume.

In practical applications, a special migration volume may be set. Therefore, a migration flag that indicates the migration volume is set for the target volume to determine the migration volume for subsequent migration. Certainly, the migration process may be interrupted, to continue migration, the migration flag may be set to find the target volume fast to continue data migration.

At S208, data objects in the original volume are sequentially copied to the target volume through a memory in order of IDs of the data objects in the original volume.

At S209, the ID of a latest completely copied data object is recorded in the target volume so as to determine a migration progress of the data objects by use of the ID of the data object.

At S210, the ID of the latest completely copied data object is recorded in the memory so as to determine the migration progress of the data objects by use of the ID of the data object in the memory.

During data migration, a memory may be used to relay the data for buffering. It can be understood that, compared with an underlying program, the memory may be accessed more conveniently and fast. Therefore, after the ID of the latest completely copied data object is recorded in the target volume, the target volume may send the ID to the memory to synchronously update an ID of the latest completely copied data object in the memory. As such, the ID of the latest completely copied data object recorded in the memory may be directly accessed to determine a current data migration process without accessing the underlying target volume. Therefore, the judgment speed is accelerated.

The memory may be a virtual memory created by the librbd.

At S211, the original volume is deleted after the data of the original volume is all migrated.

It can be understood that the original volume may be deleted to complete migration after the data of the original volume is all migrated.

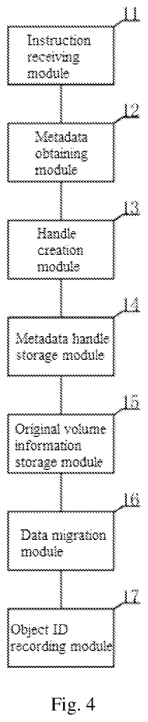

Correspondingly, an embodiment of the present disclosure also discloses a distributed storage volume online migration system. As shown in FIG. 4, the system includes:

an instruction receiving module 11, configured to receive a migration instruction sent by a user terminal;

a metadata obtaining module 12, configured to obtain, by use of the migration instruction, a metadata object that stores metadata of an original volume, the original volume is a volume that corresponds to the migration instruction and includes data required to be migrated to a target volume;

a handle creation module 13, configured to create a metadata context handle and a data context handle in a target storage pool corresponding to the migration instruction, the target storage pool corresponds to the target volume corresponding to the migration instruction;

a metadata handle storage module 14, configured to store the metadata object to the metadata context handle such that the target storage pool is accessible by use of information corresponding to the metadata object;

an original volume information storage module 15, configured to store, to the target volume, an original volume information field in the metadata object such that the target volume is accessible by use of information corresponding to the original volume information field;

a data migration module 16, configured to sequentially copy data objects in the original volume to the target volume in order of IDs of the data objects in the original volume; and

an object ID recording module 17, configured to record the ID of a latest completely copied data object in the target volume so as to determine a migration progress of the data objects by use of the ID of the data object.

It can be seen that, according to the embodiment of the present disclosure, the metadata object of the original volume is stored to the target storage pool and the target volume without destroying an original index relationship of the data in the original volume, whereby the target volume may be accessed by use of information of the original volume, and meanwhile, the data of the original volume may still be accessed during migration by use of the ID of the data object. In addition, access to data that has been migrated to the target volume is prioritized, and the data in the original data is no longer used as much as possible after migration. Therefore, non-perceptual storage volume online migration is implemented.

The metadata object includes a volume name object, a volume ID object, and a volume header object.

The system may further include a migration flag setting module.

The migration flag setting module is configured to set a migration flag for the target volume.

The system may further include a memory object ID recording module 17.

The memory object ID recording module 17 is configured to record the ID of the latest completely copied data object in a memory so as to determine the migration progress of the data objects by use of the ID of the data object in the memory.

The system may further include a volume deletion module.

The volume deletion module is configured to delete the original volume after the data of the original volume is all migrated.

The handle creation module 13 may include a metadata handle creation unit and a data handle creation unit.

The metadata handle creation unit is configured to create the metadata context handle in a target metadata storage pool corresponding to the migration instruction.

The data handle creation unit is configured to create the data context handle in a target data storage pool corresponding to the migration instruction.

The data migration module 16 is configured to sequentially copy the data objects in the original volume to the target volume through the memory in order of the IDs of the data objects in the original volume.

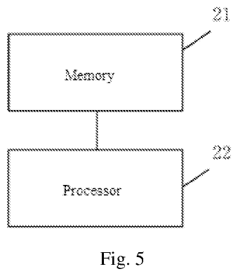

In addition, an embodiment of the present disclosure also discloses a distributed storage volume online migration apparatus, which, as shown in FIG. 5, includes:

a memory 21, configured to store a computer program; and

a processor 22, configured to execute the computer program to implement the afore-mentioned distributed storage volume online migration method.

In addition, an embodiment of the present disclosure also discloses a computer-readable storage medium, storing a computer program that is executed by a processor to implement the afore-mentioned distributed storage volume online migration method.

It is finally to be noted that relational terms herein, such as first and second, are only for distinguishing one entity or operation from another and do not necessarily require or imply the existence of any practical relation or sequence between these entities or operations. Moreover, terms “include” and “contain” or any other variation thereof is intended to cover nonexclusive inclusions, whereby a process, method, object, or device including a series of elements not only includes those elements but also includes other elements that are not clearly listed, or further includes elements intrinsic to the process, the method, the object, or the device. With no more restrictions, an element defined by statement “including a/an . . . ” does not exclude the existence of the same other elements in a process, method, object, or device including the element.

Professionals may further realize that the units and algorithm steps of each example described in combination with the embodiments disclosed herein may be implemented by electronic hardware, computer software, or a combination thereof. In order to describe the interchangeability of hardware and software clearly, the compositions and steps of each example have been described generally above according to functions. Whether these functions are executed by hardware or software depends on specific applications and design constraints of the technical solutions. Professionals may realize the described functions for each specific application by use of different methods, but such realization shall fall within the scope of the present disclosure.

The technical contents provided in the present disclosure are introduced above in detail. The principle and implementation modes of the present disclosure are described herein with specific examples. The above descriptions about the embodiments are only for helping in understanding the method of the present disclosure and the core concept thereof. In addition, those ordinarily skilled in the art may make variations to the specific implementation modes and the application scope according to the concept of the present disclosure. In summary, the contents of the specification should not be understood as limits to the present disclosure.

1. A distributed storage volume online migration method, comprising:
receiving a migration instruction sent by a user terminal;
obtaining, by use of the migration instruction, a metadata object that stores metadata of an original volume, wherein the original volume is a volume that corresponds to the migration instruction and comprises data required to be migrated to a target volume;
creating a metadata context handle and a data context handle in a target storage pool corresponding to the migration instruction, wherein the target storage pool corresponds to the target volume corresponding to the migration instruction;
storing the metadata object to the metadata context handle such that the target storage pool is accessible by use of information corresponding to the metadata object;
storing, to the target volume, an original volume information field in the metadata object such that the target volume is accessible by use of information corresponding to the original volume information field;
sequentially copying data objects in the original volume to the target volume in order of Identifiers (IDs) of the data objects in the original volume; and
recording the ID of a latest completely copied data object in the target volume so as to determine a migration progress of the data objects by use of the ID of the data object.

2. The distributed storage volume online migration method according to claim 1, wherein the metadata object comprises a volume name object, a volume ID object, and a volume header object.

3. The distributed storage volume online migration method according to claim 1, wherein the method further comprises:
setting a migration flag for the target volume.

4. The distributed storage volume online migration method according to claim 1, wherein the step of sequentially copying the data objects in the original volume to the target volume comprises:
sequentially copying the data objects in the original volume to the target volume through a memory.

5. The distributed storage volume online migration method according to claim 4, wherein after the step of recording the ID of the latest completely copied data object in the target volume, the method further comprises:
recording the ID of the latest completely copied data object in the memory so as to determine the migration progress of the data objects by use of the ID of the data object in the memory.

6. The distributed storage volume online migration method according to claim 1, wherein the method further comprises:
deleting the original volume after the data of the original volume is all migrated.

7. The distributed storage volume online migration method according to claim 1, wherein the step of creating the metadata context handle and the data context handle in the target storage pool corresponding to the migration instruction comprises:
creating the metadata context handle in a target metadata storage pool corresponding to the migration instruction; and
creating the data context handle in a target data storage pool corresponding to the migration instruction.

8. (canceled)

9. A distributed storage volume online migration apparatus, comprising:
a memory, configured to store a computer program; and
a processor, configured to execute the computer program, and upon execution of the computer program, is configured to:
receive a migration instruction sent by a user terminal;
obtain, by use of the migration instruction, a metadata object that stores metadata of an original volume, wherein the original volume is a volume that corresponds to the migration instruction and comprises data required to be migrated to a target volume;
create a metadata context handle and a data context handle in a target storage pool corresponding to the migration instruction, wherein the target storage pool corresponds to the target volume corresponding to the migration instruction;
store the metadata object to the metadata context handle such that the target storage pool is accessible by use of information corresponding to the metadata object;
store, to the target volume, an original volume information field in the metadata object such that the target volume is accessible by use of information corresponding to the original volume information field;
sequentially copy data objects in the original volume to the target volume in order of Identifiers (IDs) of the data objects in the original volume; and
record the ID of a latest completely copied data object in the target volume so as to determine a migration progress of the data objects by use of the ID of the data object.

10. A non-transitory computer-readable storage medium,
storing a computer program that is executable by a processor, and upon execution by the processor, is configured to cause the processor to:
receive a migration instruction sent by a user terminal;
obtain, by use of the migration instruction, a metadata object that stores metadata of an original volume, wherein the original volume is a volume that corresponds to the migration instruction and comprises data required to be migrated to a target volume;
create a metadata context handle and a data context handle in a target storage pool corresponding to the migration instruction, wherein the target storage pool corresponds to the target volume corresponding to the migration instruction;
store the metadata object to the metadata context handle such that the target storage pool is accessible by use of information corresponding to the metadata object;
store, to the target volume, an original volume information field in the metadata object such that the target volume is accessible by use of information corresponding to the original volume information field;
sequentially copy data objects in the original volume to the target volume in order of Identifiers (IDs) of the data objects in the original volume; and
record the ID of a latest completely copied data object in the target volume so as to determine a migration progress of the data objects by use of the ID of the data object.

11. The distributed storage volume online migration apparatus according to claim 9, wherein the metadata object comprises a volume name object, a volume ID object, and a volume header object.

12. The distributed storage volume online migration apparatus according to claim 9, wherein the processor, upon execution of the computer program, is further configured to:
set a migration flag for the target volume.

13. The distributed storage volume online migration apparatus according to claim 9, wherein the processor, upon execution of the computer program, is further configured to:
sequentially copy the data objects in the original volume to the target volume through a second memory.

14. The distributed storage volume online migration apparatus according to claim 13,:
record the ID of the latest completely copied data object in the second memory so as to determine the migration progress of the data objects by use of the ID of the data object in the second memory.

15. The distributed storage volume online migration apparatus according to claim 9, wherein the processor, upon execution of the computer program, is further configured to:
delete the original volume after the data of the original volume is all migrated.

16. The distributed storage volume online migration apparatus according to claim 9, wherein the processor, upon execution of the computer program, is further configured to:
create the metadata context handle in a target metadata storage pool corresponding to the migration instruction; and
create the data context handle in a target data storage pool corresponding to the migration instruction.

17. The non-transitory computer-readable storage medium according to claim 10, wherein the metadata object comprises a volume name object, a volume ID object, and a volume header object.

18. The non-transitory computer-readable storage medium according to claim 10, wherein the computer program, upon execution by the processor, in order to cause the processor to:
set a migration flag for the target volume.

19. The non-transitory computer-readable storage medium according to claim 10, wherein the computer program, upon execution by the processor, in order to cause the processor to:
sequentially copy the data objects in the original volume to the target volume through a memory.

20. The non-transitory computer-readable storage medium according to claim 19, wherein the computer program, upon execution by the processor, in order to cause the processor to:
record the ID of the latest completely copied data object in the memory so as to determine the migration progress of the data objects by use of the ID of the data object in the memory.

21. The non-transitory computer-readable storage medium according to claim 10, wherein the computer program, upon execution by the processor, in order to cause the processor to:
delete the original volume after the data of the original volume is all migrated.
